(19) United States
(12) Patent Application Publication
(10) Pub. No.: US 2017/0330186 A1
(43) Pub. Date: Nov. 16, 2017

(54) Decision Engine for Payments

(71) Applicant: GK Software USA, Inc., Raleigh, NC (US)

(72) Inventor: David Robin Vaughan, Raleigh, NC (US)

(21) Appl. No.: 15/151,540

(22) Filed: May 11, 2016

(51) Int. Cl. G06Q 20/40

(52) U.S. Cl. CPC G06Q 20/409

(57) ABSTRACT

A system and method that changes the payment flow at the point of sale and an EFT device based upon the Transaction Factors, so that the customer is guided during their interaction with the transaction based upon the card that they are utilizing, the payment types supported by that card, and their cash back selection, such that the transaction incurs the least cost for the retailer. The system generates an authorization message from data elements gathered from dynamic cashier and customer prompting, the EFT payment device, and static configuration for the location.

This application claims the benefit of U.S. Provisional Patent Application 61/863,201, filed on Aug. 7, 2013 and U.S. Non-Provisional Patent Application No. 14/312821, filed on Jun. 24, 2014.

### FIELD OF THE INVENTION

The embodiments disclosed herein relate to a system architecture and a method to reduce fees and costs associated with electronic point-of-sale payments, while maximizing fees collected during the transaction. In particular, the present invention reduces costs associated with the authorization and settlement of credit and debit card transactions. The invention is an Electronic Funds Transfer (“EFT”) System that acquires data elements gathered from dynamic customer and cashier prompting, an EFT payment device, and static configuration for the site of the point-of-sale. The System then composes a message, either binary or text, from the gathered elements in a manner corresponding to an authorization processor message definition.

### BACKGROUND OF THE INVENTION

Credit and debit cards, along with the advent of electronic sales and services transactions, have changed forever how the U.S. and global marketplaces function. Point-of-sale purchases are those purchases made at the physical location where the retail goods or services are provided. Retailers accept a wide variety of payment methods, each of which carries with it its own processing and handling costs, and impacts the handling of customers (both physically and electronically) in different ways. Transactions of this type are generally handled by and through an electronic fund transfer (EFT) device, such as the combination of a cash register and a debit/credit card reader.

If a retailer were able to choose for each customer the specific payment to use for a given transaction, the decision would be based upon a number of factors (the “Transaction Factors”), including:

The balance of the transaction

The payment methods that the customer has available

The payment types available for a given payment method, such as Debit or Signature Cards

Whether the customer will be requesting cash back on the transaction, and if there are fees captured or other benefits associated with the cash back transaction

Third party discounts or incentives associated with a given payment type

Chargeback or inquiry rates associated with a given payment type, and the costs of retaining a signature or receipt

The length of time to process the customer in the lane (e.g., whether or not a signature is required)

The impact of payment choices on the availability of funds

Store-related costs associated with the labor for a particular payment type

Fees associated with authorizing and settling the card payment utilizing a particular payment type (e.g., whether or not the bank providing the card is regulated or unregulated under the Durbin Amendment)

Other changes and impacts that occur as a result of changes in banking and regulatory structures, fee agreements, and the like

Technologies exist to process point-of-sale electronic payments. However, prior payment processing means are limited in that payment handling was determined solely from the first digits of the card at issue. The use of the above Transaction Factors is needed in order to arrive at the retailer's preferred method of payment, usually minimizing their associated costs.

What is needed, therefore, is a system and method that changes the payment flow at the point of sale and an EFT device based upon the Transaction Factors, so that the customer is guided during their interaction with the transaction based upon the card that they are utilizing, the payment types supported by that card, and their cash back selection, such that the transaction incurs the least cost for the retailer.

While the discussion herein discusses the invention in terms of retail sales, it will be understood that the method may be applied to other transactions, such as service sales, wholesale purchases, and the like.

### SUMMARY OF THE INVENTION

The present invention is related to a system for handling and authorizing point of sale payments. In particular, the present invention dynamically alters the manner in which a payment is handled in a point of sale transaction such that the retailer's costs are minimized.

### BRIEF DESCRIPTION OF THE DRAWINGS

FIG. 1 illustrates the High Level Flow of the present invention.

FIG. 2 illustrates the inputs to cost that are utilized in dynamically predicting costs of payment handling.

FIG. 3 illustrates the elements utilized to generate a recommended transaction.

FIG. 4 illustrates an embodiment of the present invention showing a dynamically-guided consumer purchase process.

FIG. 5 illustrates an embodiment of the present invention showing decision components for a dynamically guided consumer purchase process in accordance with an embodiment of the present invention.

FIG. 6 illustrates a system in accordance with an embodiment of the present invention.

FIG. 7 illustrates the inputs to a message building process.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made.

Electronic funds transfer (EFT) is a fairly broad term used to cover the electronic transfer of money from one bank account to another, either within a single financial institution or across multiple institutions, through computer-based systems and without the direct intervention of bank staff.

The term covers a number of different payment systems, for example:
cardholder-initiated transactions, using, a payment card such as a credit or debit card
direct deposit payment initiated by the payer
direct debit payments for which a business debits the consumer's bank accounts for payment for goods or services
wire transfer via an international banking network
electronic bill payment in online banking, which may be delivered by EFT or paper check.

The present invention performs operates as part of the processing for the first of these Payment Systems, and specifically relates to purchase transactions. In addition, the Payment System can be regarded as covering the complete lifecycle of the payment—Authorization, Batching, Clearing and Settlement, Funding and Chargebacks. The present invention applies only to the Authorization component of the Payment System, and is unique to the electronic payment process. The Authorization component as disclosed herein is incapable of being performed outside of an EFT System and, in fact, has no bearing on payments that are not electronic in nature. The invention uses computer processing to control and influence the first steps of EFT System Purchase Authorization.

In a cardholder-initiated transaction using a payment card to purchase goods or services, the following specific functions are performed for the Authorization of the purchase in the following manner:
1. The cardholder account information (account number, expiration date, etc.) is collected by the EFT system by:
   a. Swiping the card's magnetic stripe through an electronic magnetic stripe reader (MSR) of an EFT Device or POS (Point of Sale) Cash Register.
   b. Placing the card's computer chip in contact with an electronic chip reader of an EFT Device under control of the computer and performing a series of communications between the reader and the card's computer chip.
   c. An EFT Device communicating contactlessly via Radio Frequency or other Contactless communications.
   d. Manually keying the cardholder information into the computer (POS Cash Register or EFT Device).
2. If required, additional information is electronically collected from the cardholder for the purposes of authorizing the purchase by interaction with the screen or keyboard on an EH Device. Examples of the additional information that can be required are: account selection (Credit or Debit); Application Selection (for chip cards); ZIP code; cash back selection. Where the EFT Device is not capable or not used, entries can be communicated to the cashier and made on the POS Cash Register)
3. The EFT System building a data message containing the account information gathered in 1; additional cardholder inputs described in 2; information about the purchase (e.g. amount, transaction identifier, local date/time, and if applicable, fees); and merchant identification.
4. The EFT System electronically transmits the data message in the prescribed manner directly or indirectly to the card issuer to request authorization of the purchase, and waits for a data message in response that contains the results of the authorization response.
5. The card issuer or their proxy determines whether the purchase can be authorized or not, and electronically transmits the results of this determination directly or indirectly back to the EFT System.
6. The EFT System parses the data message to determine whether to accept the purchase or not, can commutate the result to either or both of the POS Cash Register and the cardholder (often using the EFT Device).

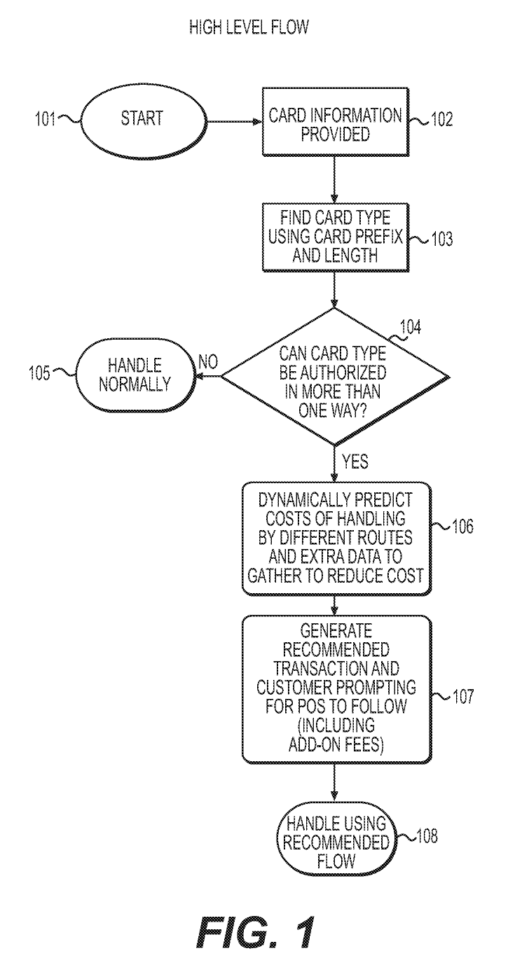

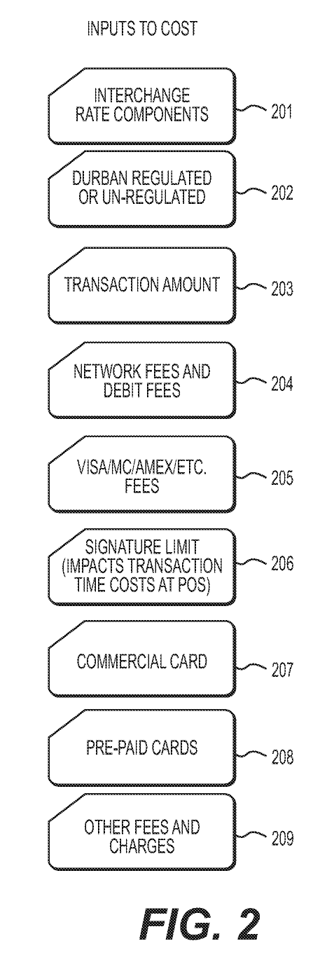

Referring now to FIG. 1, a High Level Flow of the present invention is shown. At the start 101, the card information is provided 102. This is generally done through the process of a point of sale customer “swiping” the magnetic strip located on credit and debit cards through an electronic card reader, but the card information may also be provided by manually keying in the care information at the point of sale register, or by other means. The card type is determined 103 by utilizing the card prefix and the length of the card number. Once the card type is determined 103, whether or not the card can be authorized in more than one way is determined 104. If the card cannot be authorized in more than one way, the transaction is handled normally 105 with no dynamic prediction 106. If the card may be authorized in more than one manner, the costs of handling are dynamically predicted 106, utilizing the Inputs to Cost (FIG. 2). Once the costs of handling are predicted 106, a recommended transaction and customer prompting is generated 107, based upon the dynamic prediction 106 of the transaction with the least transaction costs for the point of sale retailer. The transaction is then handled 108 utilizing the recommended transaction.

Referring now to FIG. 2, Inputs to Cost that are utilized for the step of dynamically predicting (FIG.1, 106) the costs of handling. These Inputs may comprise: interchange rate components 201; the presence or lack of Durban regulations 202 (Durbin regulations allow the U.S. Federal Reserve the power to regulate debit card interchange fees); the transaction amount 203; network and debit fees 204; card issuer (Visa, MasterCard, American Express, etc.) fees 205; any applicable signature limit 206, which impacts transaction costs at the point of sale, whether the card is a commercial card 207, whether the card is a pre-paid card 208, and other associated fees and costs 209. It will be understood that this list is not exhaustive; transaction costs change not just in value but in type over time, and the present invention takes into account this shifting landscape of Inputs to Cost.

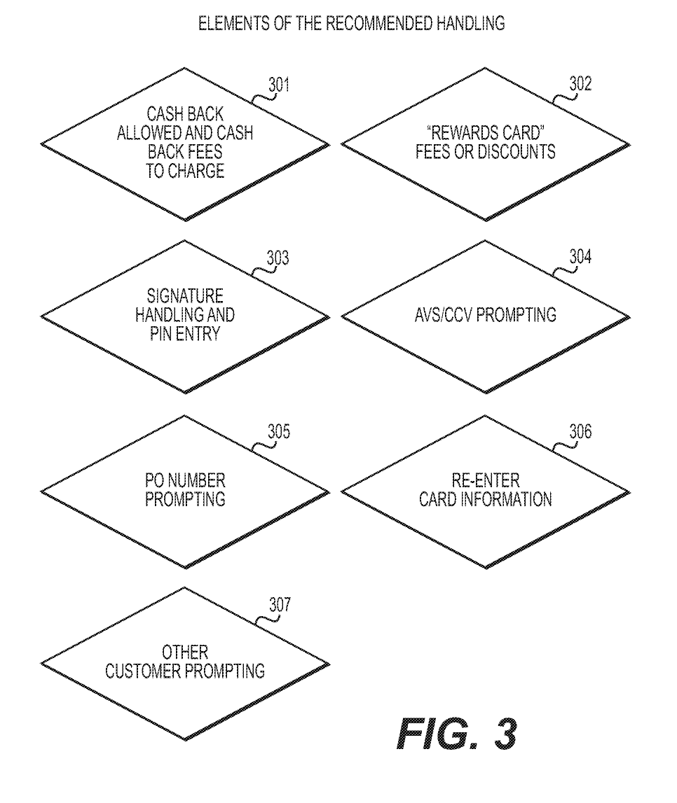

Referring now to FIG. 3, once the costs of handling are dynamically predicted (FIG. 1, 106), the generation of the recommended transaction and customer prompting (FIG. 1, 107) is comprised of one or more elements. These elements include: cash back awards and cash back fees to charge 301; “rewards” card fees or discounts 302; signature handling and PIN entry 303; AVS/CCV prompting 304 (these are the three- or four-digit security numbers utilized on credit and debit cards); PO number prompting 305, whether or not to re-enter the card information 306, and other customer prompting 307. It will be understood that the Elements of Recommended Handling identified herein is not exhaustive. There are changes to card processing that occur over time, and the present invention is structured such that those changes will be taken into account as they occur for recommending transaction and customer prompting.

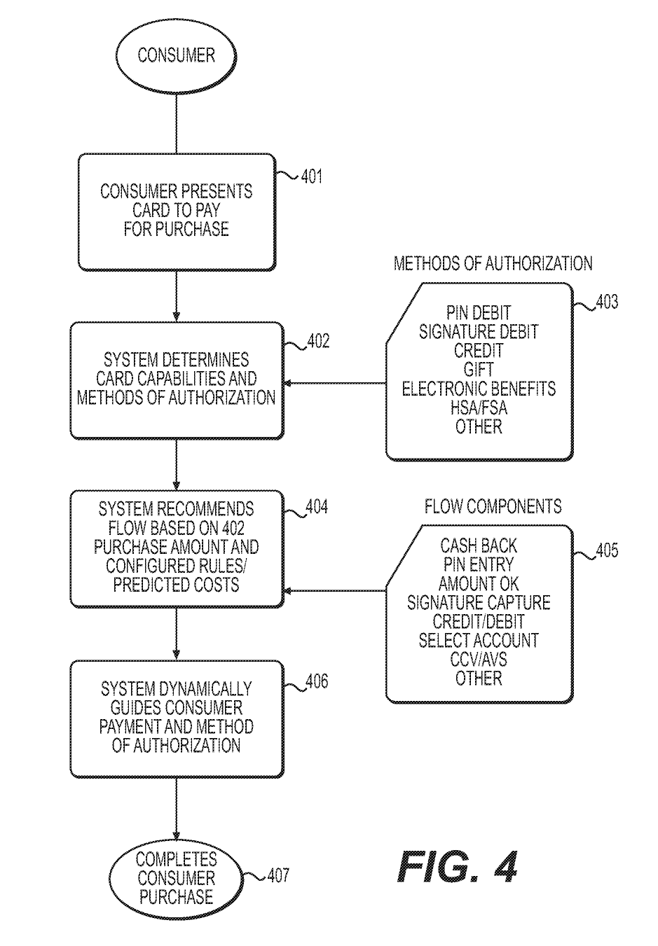

FIG. 4 shows an alternate flow chart in accordance with an embodiment of the present invention. A consumer presents a card to pay for a purchase 401. The system determines 402 the card capabilities and the methods of authorization. The methods of authorization 403 can include such parameters as pin debit, signature debit, credit, gift, electronic benefits, HSA/FSA, or other authorization methods. It will be understood that, as the marketplace progresses and changes, available authorization methods may change and such new or changed authorization methods can be incorporated into the present invention without deviating from the scope of the invention. The system then recommends flow 404 based upon the system determinations in 402, as well as the purchase amount and configured rules/predicted costs. The flow components 405 may include cash back, PIN entry, amount ok (authorization of purchase) signature capture, the choice of credit or debit, selection of account that the card is associated with, or other flow components. As with the methods of authorization 403, it will be understood that the set of flow components to choose from may change as the marketplace use of cards is modified and evolves, and the set of potential flow components may change without deviating from the scope of the present invention. Once the system has recommended a flow 404, the system dynamically guides 406 the consumer payment and method of authorization and completes the customer purchase 407.

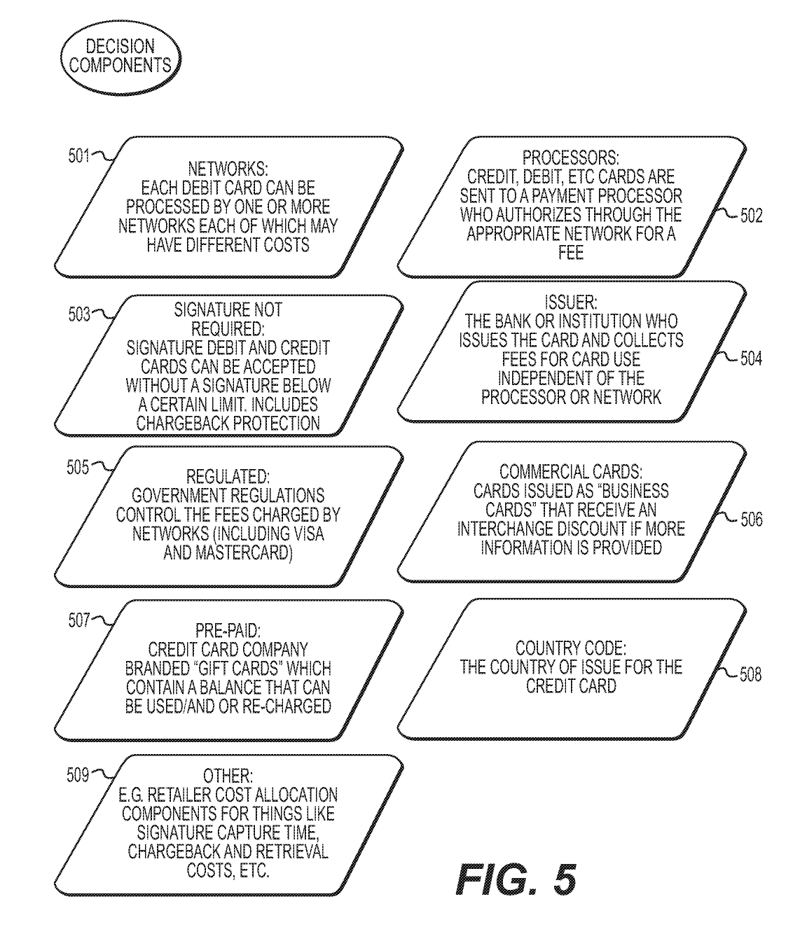

Decision components (FIG. 5) for determining the flow for dynamically guiding the customer's payment and method of authorization include networks 501, processors 502, signature not required 503, issuer 504, regulated 505, commercial cards 506, pre-paid 507, country code 508, or other components 509. For networks 501, each debit card can be processed by one or more networks, each of which may have different costs which are considered when guiding the purchasing process. For processors 502, requests for payments on credit or debit cards, the information is sent to a payment processor. The payment processor authorizes the payment through an appropriate network and charges a fee for doing, so. Below a certain purchase limit, neither signature nor PIN may be required 503 for a particular card. This component further includes chargeback protection. The system also considers the issuer 504; the bank or institution that issued the card and collects fees for the card's use independent of the network 501 or the processor 502. The system also considers whether or not the transaction is regulated 505. Government regulations control the fees charged by networks (501) and are taken into consideration when determining a recommended system flow. There are also commercial cards 506. Commercial cards are issued as “business cards” that receive an interchange discount if more information is provided. Pre-paid 507 cards include credit card companies branded “gift cards.” Such “gift cards” contain a balance placed upon them at the time of the purchase of the gift card. The balance is depleted as it is used, and in some cases the card allows the balance to be refilled or re-charged with payments to add additional monetary value to the card. The system further considers the country code 508, which identifies the country of issue for the card. Finally, there may be other 509 components taken into account by the system, such as retailer cost allocation and components for additional items such as signature capture time, chargeback and retrieval costs, and the like. These other 509 components may also change, be added to or modified as the marketplace and cards change to include other components. Such changes, additions or modifications will be understood to not fall outside the scope and intention of the present invention.

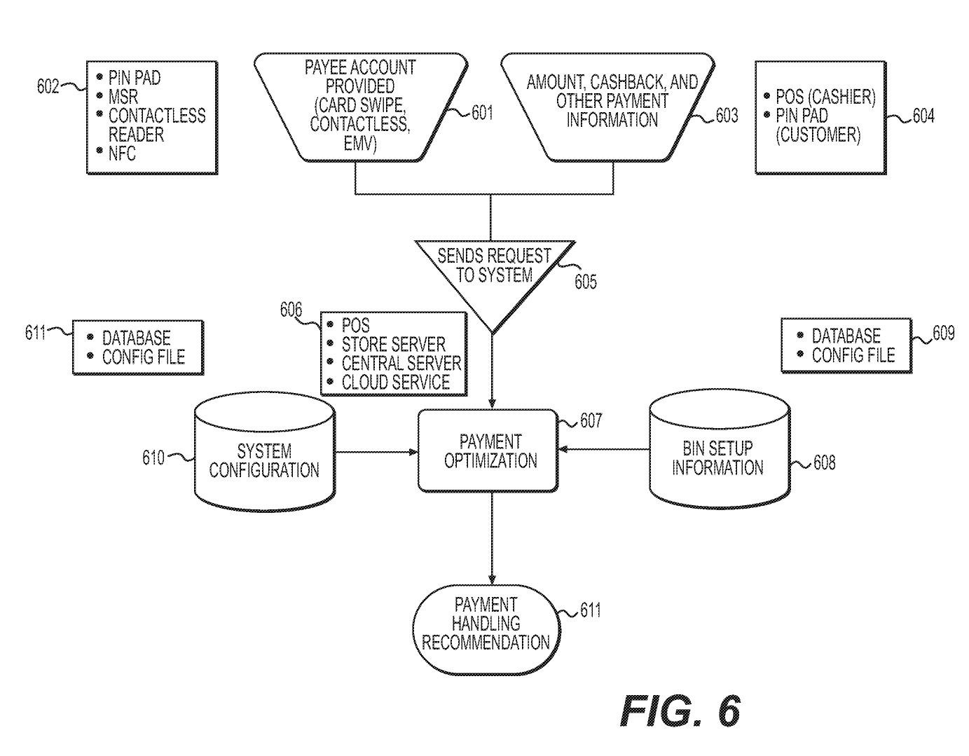

FIG. 6 shows a system configuration in accordance with an embodiment of the invention. A first input interface 601 receives account information from a payee. The payment interface device 601 may be chosen from the list comprising 602 a PIN Pad, MSR (magnetic card (stripe) reader), a contactless card reader, an NFC device (near field communication device), or similar device. Through 604 point of sale information entered by the cashier or by the customer, a second input interface 603 communicates second information to the system, second information being the amount, cashback and other payment information. In a standard configuration, the cashier operates a register that may also be used as a first and second input interface, and communicates with the payment interface device 601.

The payment request is sent 605 to the system processor 606. The system processor 606 may be resident in the payment interface device 601, a store server, a central server, or may be provided through a cloud service. A third input interface 608 communicates third information to the system 607, the third information being permitted authorization methods and payee account handling options based upon the prefix of the payee account. The third input interface 608 communicates BIN (bank identification number) setup information to the system, the BIN setup information may comprise information 609 from a database or a configuration file. A fourth input interface 610 communicates fourth information 611 to the system, the fourth information containing the configuration of desired payee account handling based upon the second and third information derived from the first information. The first, second, and third information are processed by the system to determine the configuration of desired payee account handling, and the payment optimization 607. Once payment optimization 607 is determined by the system, the payment handling recommendation 612 is communicated to the payment interface devices.

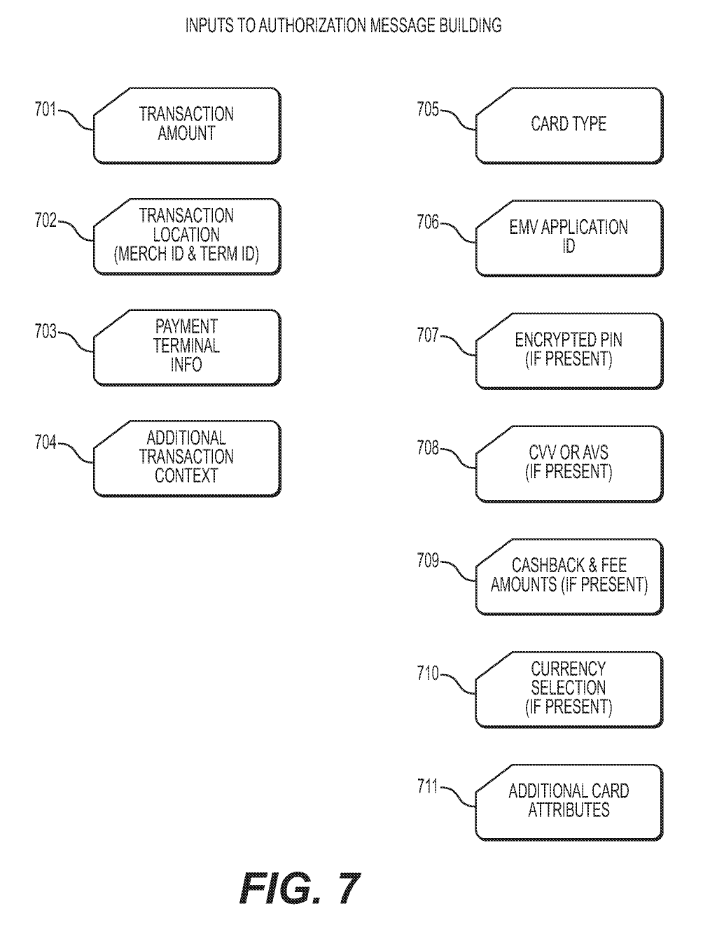

Referring now to FIG. 7, shown are inputs to a message building process. These inputs, in one embodiment, are utilized in the following simple credit authorization:

<Credit>
<PayType>Credit</PayType>
<TxnType>Sale</TxnType>
<LocalDateTime>20141111114040</LocalDateTime>
<SendDateTime>20141111164040</SendDateTime>
<RefNum>000000000001</RefNum>
<TxnNum>1</TxnNum>
<TerminalID>00000001</TerminalID>
<MerchantID>1234567890</MerehantID>
<EntryMode>Keyed</EntryMode>
<POSCondCode>XX</POSCondCode>
<TermCode>XX</TermCode>
<TermEntryCap>XX</TermEntryCap>
<TxnAmount>100</TxnAmount>
<TxnCurrency>840</TxnCurrency>
<CardNum>4111~~~~~~~~1111</CardNum>
<CardExpiryDate>201812</CardExpiryDate>
<CardType>Visa</CardType>
</Credit>

The data elements are chosen from one or more of the set comprising transaction amount 701, transaction location 702, payment terminal information 703, additional transaction content 704, card type 705, EMV application ID 706, encrypted PIN 707, CVV or AVS 708, cashback and fee amounts 709, currency selection 710, and additional card attributes 711. The content of the message is controlled to a significant extent by the data elements gathered from the customer, and so the dynamic nature of the prompting results in different messages or data elements in the message depending on the prompts presented. The message is then sent to the authorization processor according to the communications protocols specified by that processor. Examples of these include HTTPS, TCP/IP over SSL, Dial, and Proprietary APIs.

Electronically Receiving and Parsing the Authorization Response

The authorization processor receives the message and contacts the card issuer to attempt to obtain an authorization for the card and the transaction. The route the authorization processor uses to contact the card issuer, and in some cases the card issuer itself, is dictated by the contents of the authorization message.

One embodiment utilizing the above example is as follows:

<Credit> . . . </Credit>: message sent to a credit card issuer (e.g. Visa, MasterCard, Discover, American Express, etc.)

<Debit> . . . <PIN>xxxxxxxxxxxxxxxxx</PIN> . . . </Debit>: message sent to a debit network (e.g. Star, Interlink, Pulse, NYCE, etc.)

Upon completion of the authorization, the authorization result is communicated back to the EFT System by the authorization processor. This is done by transmitting an authorization response message to the EFT system in a format specified by the authorization processor over a communication protocol specified by the authorization processor.

The EFT System includes the ability to parse or separate the elements of this authorization response from authorization processor, including some or all of the following elements:

Approval, Decline or Referral indication

Network Reference Number that can be used to reference the transaction

Approved Amount (which may be less than the amount requested)

Token (which can be used in place of the card number in future transactions)

An example of an Authorization Response is shown below:

<CreditResponse>
<PayType>Credit</PayType>
<TxnType>Sale</TxnType>
<LocalDateTime>20141111114040</LocalDateTime>
<SendDateTime>20141111164040</SendDateTime>
<RefNum>000000000001</RefNum>
<TxnNum>1</TxnNum>
<TerminalID>00000001</TerminalID>
<MerchantID>1234567890</MerchantID>
<EntryMode>Keyed</EntryMode>
<POSCondCode>XX</POSCondCode>
<TermCode>XX</TermCode>
<TermEntryCap>XX</TermEntryCap>
<TxnAmount>100</TxnAmount>
<TxnCurrency>840</TxnCurrency>
<Token>123123123123123123123</Token>
<IssuerReferenceCode>01431564</IssuerReferenceCode>
<ResponseCode>000</ResponseCode>
<AuthID>OK1234</AuthID>
<Message>APPROVAL</Message>
</CreditResponse>

The above description and drawings illustrate embodiments which achieve the objects, features, and advantages described. Although certain advantages and embodiments have been described above, those skilled in the art will recognize that substitutions, additions, deletions, modifications and/or other changes may be made.

What is claimed is:

1. A method for handling a customer payment interaction at a point of sale utilizing an electronic fund transfer (“EFT”) device and where the payment flow is changed at the point of sale and EFT device based upon transaction factors and retailer configured preferences for those transaction factors;
data elements are gathered from dynamic customer and cashier prompting;
an authorization message is composed from the data elements in a manner corresponding to an authorization processor message definition;
the authorization message is received by an authorization processer;
the authorization processor contacts the card issuer to obtain authorization for the transaction; and
an authorization response is communicated back to the EFT system by the authorization processor over a communication protocol specified by the authorization processor.

2. The method of claim 1 wherein transaction factors are chosen from the list comprising:
the balance of the transaction; the payment methods available to the customer; the payment types available for a given payment method, such as debit or signature cards;
whether the customer will be requesting cash back on the transaction and if there are fees captured or other benefits associated with the cash back transaction; third party discounts or incentives associated with a given payment type or processing option; chargeback or inquiry rates associated with a given payment type and the costs of retaining a signature or receipt; the anticipated length of time to process the customer in a purchase setting such as in a checkout line and whether or not a signature is required; the impact of payment choices on the availability of funds; store-related costs associated with the labor for a particular payment type; fees associated with the authorizing and settling the card payment utilizing a particular payment type, e.g., whether or not the bank providing the card is regulated or unregulated; and other changes and impacts that occur as a result of changes in banking and regulatory structures and fee agreements.

3. The method of claim 2 wherein the customer is guided during their interaction with the transaction based upon the card that they are utilizing, the payment types supported by that card, and their cash back selection, such that the transaction follows the retailer's configured preferences.

4. The method of claim 2 wherein the authorization message is built using inputs chosen from the group comprising: transaction amount, transaction location, payment terminal information, additional transaction context, card type, EMV application ID, encrypted PIN, CVV or AVS, cashback and fee amounts, currency selection, and additional card attributes.

5. The method of claim 4 wherein the content of the authorization method is determined from data elements gathered from the customer and is dynamically determined at the time of sale.

6. The method of claim 5 wherein the authorization method is communicated to an authorization processor according to communications protocols specified by that processer.

7. The method of claim 6 wherein the communications protocols are chosen from the group comprising: HTTPS, TCP/IP over SSL, Dial, and proprietary APIs.

8. The method of claim 1 further comprising the step of parsing elements of the authorization response, the parsed elements chosen from the group comprising: approval, decline, or referral indication; network reference number; approved amount; and token.
